(19) United States
(12) Patent Application Publication
(10) Pub. No.: US 2012/0100246 A1
(43) Pub. Date: Apr. 26, 2012

(54) SLIDE CORE-PULLING DELAYED MECHANISM AND MOULD WITH THE SAME

(75) Inventors: XIAO-PING WU, Tu Cheng (TW); Gang-fu Cai, Tu Cheng (TW); Shih-hsiung Ho, Tu Cheng (TW); Kun-hsueh Chiang, Tu Cheng (TW)

(73) Assignee: Cheng Uei Precision Industry Co,, LTD., Tu Cheng City (TW)

(21) Appl. No.: 12/909,708

(22) Filed: Oct. 21, 2010

(51) Int. Cl. B29C 45/44; B29C 45/36

(52) U.S. Cl. 425/577

(57) ABSTRACT

Provided are a slide core-pulling delayed mechanism and a mould with the same. The slide core-pulling delayed mechanism includes a slide base, a core-pulling guide block and two slide-guiding rails. The two slide-guiding rails are parallel to each other. The slide base is slidably connected to the two slide-guiding rails. The core-pulling guide block has a vertical portion and a tilted portion. The slide base disposes a sliding hole corresponding to the core-pulling guide block. The sliding hole has a first vertical wall, a first tilted wall, a second tilted wall and a second vertical wall. The core-pulling guide block is slidably inserted into the sliding hole. During the dismoulding process, the core-pulling actions of the cavity plate and the slide insert can not be interfered each other for making the dismoulding process be successfully completed and avoiding giving a harmful effect on the product.

### BACKGROUND OF THE INVENTION

1. Field of the Invention

The present invention relates to an injection mould, and more particularly to a slide core-pulling delayed mechanism and a mould with the same.

2. Description of the Prior Art

With the popularization of plastic products, an injection mould is used more and more widely. The core-pulling process is absolutely necessary in producing many injection products, and can influence the quality of the products and the production efficiency. At present, core-pulling modes includes vertical core-pulling mode, side core-pulling mode and so on.

However, when the finished product disposes a hole formed by a slide block, and when a cavity insert and a slide insert are inserted into each other, the cavity insert and the slide insert need perform the core-pulling action in order of precedence for avoiding interference each other and assuring the product quality. But the conditional core-pulling mechanism still cannot completely solve the above question.

Hence, it is needed to provide a slide core-pulling delayed mechanism for efficiently controlling the precedence of core-pulling actions of the cavity insert and the slide insert.

### BRIEF SUMMARY OF THE INVENTION

An object of the present invention is to provide a slide core-pulling delayed mechanism for efficiently controlling the precedence of core-pulling actions of the cavity insert and the slide insert.

Another object of the present invention is to provide a mould with a slide core-pulling delayed mechanism for efficiently controlling the precedence of core-pulling actions of the cavity insert and the slide insert.

To achieve the above object, in accordance with the present invention, a slide core-pulling delayed mechanism is provided for being used in a core-pulling process of a mould. The slide core-pulling delayed mechanism comprises a slide base, a core-pulling guide block and two slide-guiding rails. The two slide-guiding rails are parallel to each other. The slide base is slidably connected to the two slide-guiding rails. The core-pulling guide block has a vertical portion and a tilted portion being bent connected to a lower end of the vertical portion. The slide base disposes a sliding hole corresponding to the core-pulling guide block. The sliding hole has a first vertical wall close to one side of the tilted portion on an upper portion thereof, a first tilted wall close to the side of the tilted portion on a lower portion thereof and bent connected to the first vertical wall, a second tilted wall far to the side of the tilted portion on the upper portion thereof, and a second vertical wall far to the side of the tilted portion and bent connected to the second tilted wall. The core-pulling guide block is slidably inserted into the sliding hole.

To achieve the above object, in accordance with the present invention, a mould is also provided. The mould comprises a top clamping plate, a cavity plate, a core plate, a slide insert, a supporting plate. The cavity plate is connected to the top clamping plate. The core plate is connected to the supporting plate. The mould further comprises a slide core-pulling delayed mechanism located between the cavity plate and the core plate. The slide core-pulling delayed mechanism includes a slide base, a core-pulling guide block and two slide-guiding rails. The two slide-guiding rails are parallel connected to the core plate. The slide base is slidably connected to the two slide-guiding rails. The slide insert is connected to the slide base. The core-pulling guide block has a vertical portion, and a tilted portion being bent connected to a lower end of the vertical portion and extending away the slide insert. The cavity and core plates separately dispose a first through hole and a second through hole for receiving the core-pulling guide block. The vertical portion passes through the first through hole of the cavity plates to be fixedly connected to the top clamping plate, and the tilted portion enters into the second through hole of the core plate. The slide base disposes a sliding hole corresponding to the core-pulling guide block. The sliding hole has a first vertical wall close to one side of the tilted portion on an upper portion thereof, a first tilted wall close to the side of the tilted portion on a lower portion thereof and bent connected to the first vertical wall, a second tilted wall far to the side of the tilted portion on the upper portion thereof, and a second vertical wall far to the side of the tilted portion and bent connected to the second tilted wall. The tilted angles of the first and second tilted walls are same as that of the tilted portion of the core-pulling guide block. The core-pulling guide block is slidably inserted into the sliding hole.

Based on the above description, the mould of the present invention employs the slide core-pulling delayed mechanism. During the dismoulding process, when the cavity plate initially starts to be lifted upward, the slide base has no movement and the slide insert cannot perform the core-pulling action. When the cavity plate is lifted up to a determined distance, the slide base just starts to transversely move outward, thereby making the core-pulling action of the slide insert be performed. Therefore the core-pulling actions of the cavity plate and the slide insert of the present invention can not be interfered each other for making the dismoulding process be successfully completed and avoiding giving a harmful effect on the product.

### BRIEF DESCRIPTION OF THE DRAWINGS

FIG. 1 is a perspective view of a mould according to one embodiment of the present invention;

FIG. 2 is an exploded view of the mould of FIG. 1;

FIG. 3 is a perspective view of a slide core-pulling delayed mechanism of the mould of FIG. 1;

FIG. 4 is a perspective view of a slide base of the slide core-pulling delayed mechanism of FIG. 3;

FIG. 5 is another perspective view of the slide base from the FIG. 4;

FIG. 6 is a sectional view of the slide base of FIG. 4;

FIG. 7 is a perspective view of a core-pulling guide block of the slide core-pulling delayed mechanism of FIG. 3;

FIG. 8 is another perspective view of the core-pulling guide block from the FIG. 7;

FIG. 9 is a perspective view of a slide-guiding rail of the slide core-pulling delayed mechanism of FIG. 3;

FIG. 10 is another perspective view of the slide-guiding rail from the FIG. 9;

FIG. 11 is a sectional schematic view of the mould of FIG. 1 under the state of being closed;

FIG. 12 is a sectional schematic view of the mould of FIG. 1, showing a cavity insert in a core-pulling state;

FIG. 13 is a sectional schematic view of the mould of FIG. 1, showing a slide insert in a core-pulling state; and

FIG. 14 is a sectional schematic view of the mould of FIG. 1 under a dismoulding state.

### DETAILED DESCRIPTION OF THE PREFERRED EMBODIMENTS

The following embodiment with reference to the accompanying drawings now has been given for detail describing the technology, the feature, the object and the effect of the present invention.

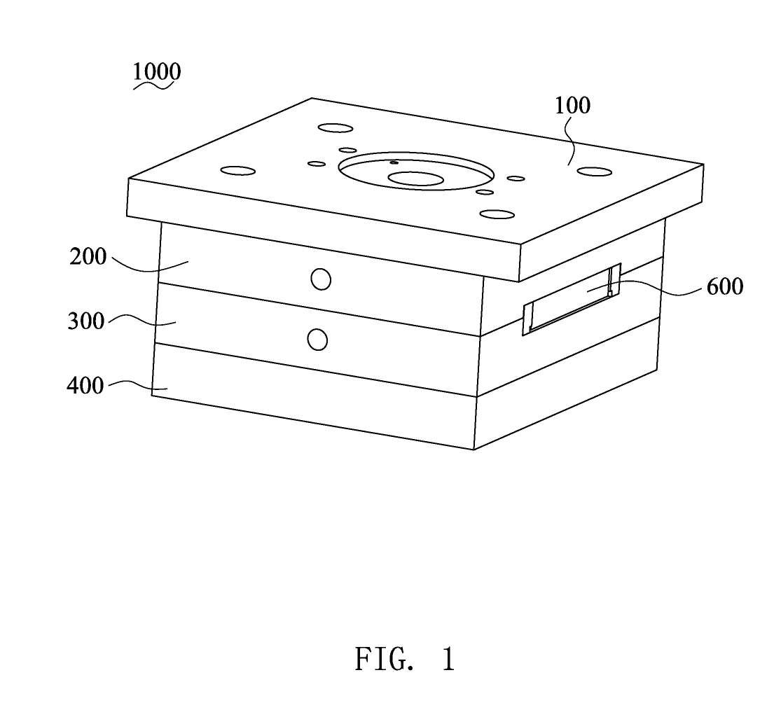

Please refer to FIGS. 1, 2 and 3, a mould 1000 of the present invention comprises a top clamping plate 100, a cavity plate 200, a core plate 300, a supporting plate 400, two slide core-pulling delayed mechanisms 500 located between the cavity plate 200 and the core plate 300, a scraping member 600, and a slide insert 700. The cavity plate 200 is connected to the top clamping plate 100. The core plate 300 is connected to the supporting plate 400. In this embodiment, the cavity plate 200 and the top clamping plate 100 are fixedly connected by bolts, and the core plate 300 is connected to the supporting plate 400 are also fixedly connected by bolts.

The cavity plate 200 disposes an upper mould cavity 210 on the middle thereof, at least two first through holes 220 separately located on two sides of the upper mould cavity 210, and two holding holes 230 located outside of each one of the first through holes 220. The core plate 300 disposes a lower mould cavity 310 on the middle thereof, and at least two second through holes 320 separately located on two sides of the lower mould cavity 310. The supporting plate 400 disposes two openings 410 separately corresponding to the two second through holes 320 and communicated with the second through holes 320.

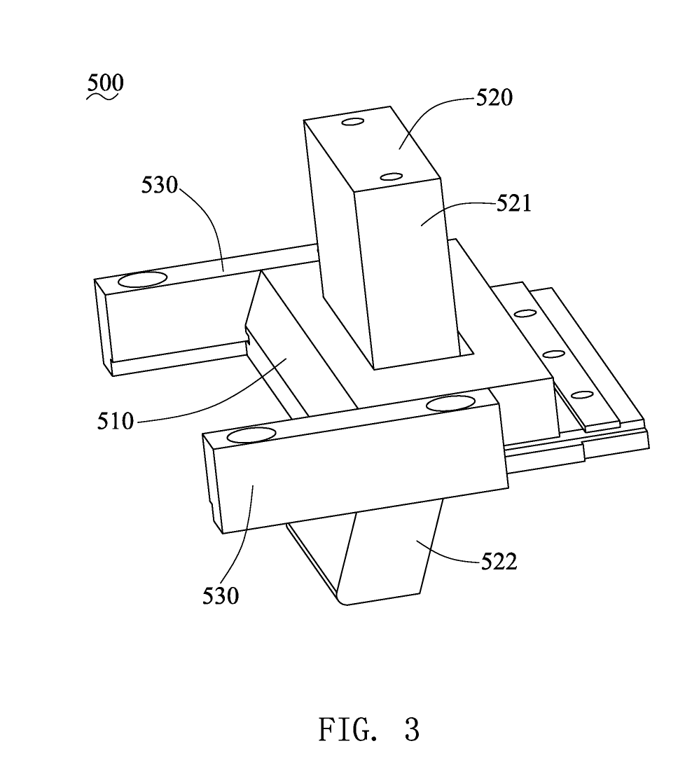

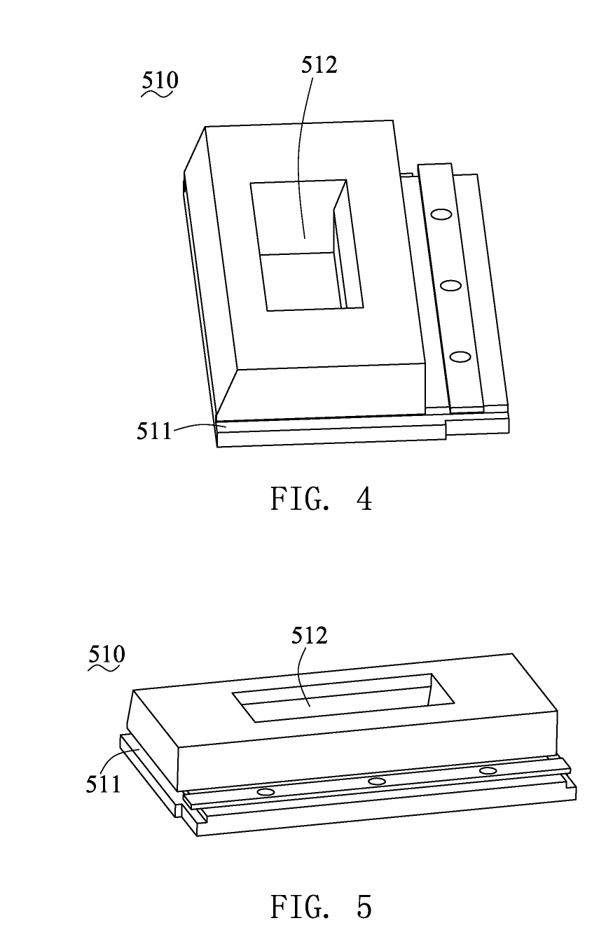

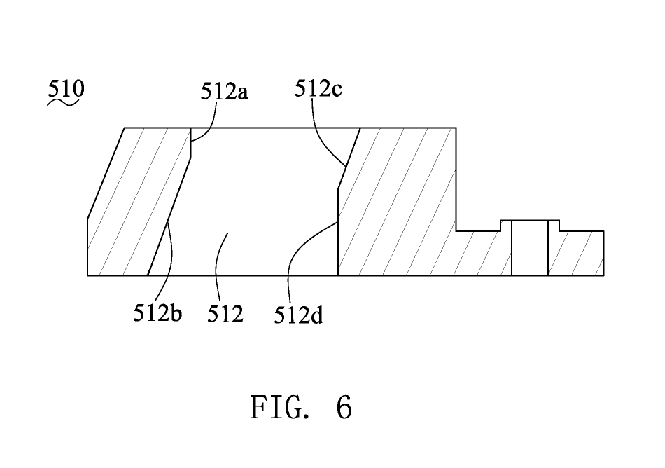

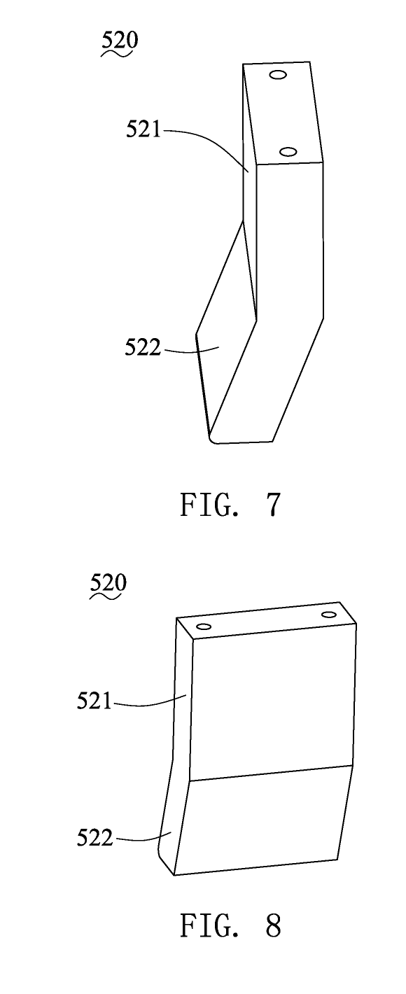

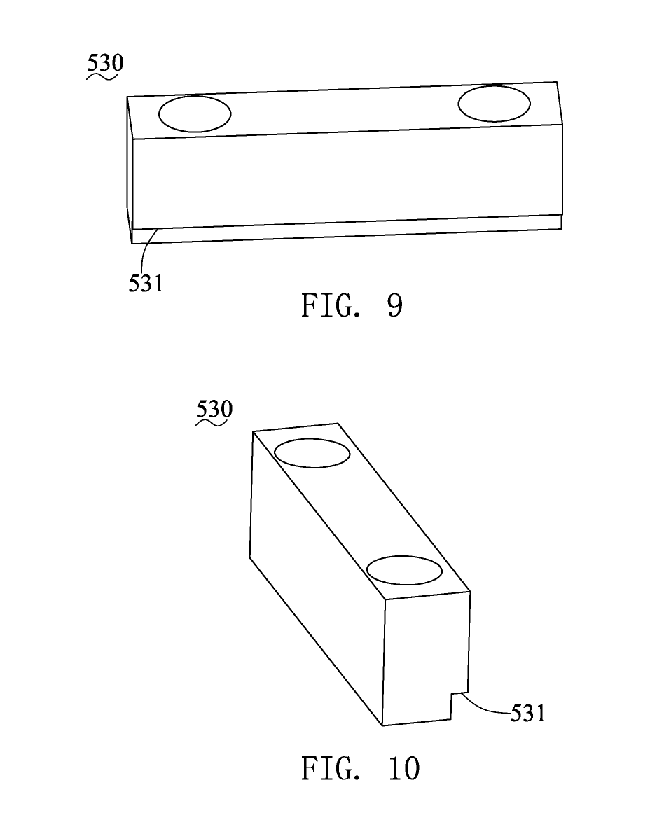

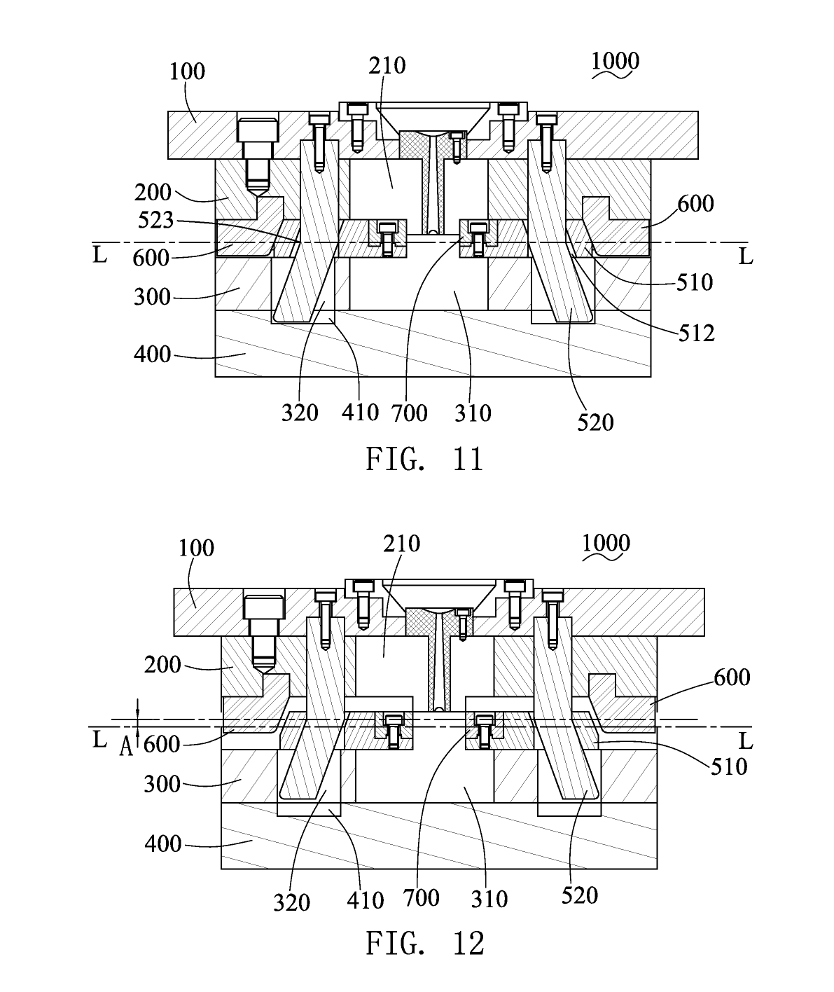

Referring to FIGS. 3 to 11, the two slide core-pulling delayed mechanisms 500 are separately mounted on two sides of the mould cavity 310, 210 of the core and cavity plate 300, 200. The slide core-pulling delayed mechanism 500 includes a slide base 510, a core-pulling guide block 520 and two slide-guiding rails 530, as shown in FIG. 3. The two slide-guiding rails 530 are parallel fixed to the core plate 300 by bolts. The slide base 510 disposes a first guiding groove 511 on a lower portion thereof, as shown in FIGS. 4 and 5. Each one of the two slide-guiding rails 530 disposes a second guiding groove 531 on a lower portion thereof, as shown in FIGS. 9 and 10. The first and second guiding grooves 511, 531 can be engaged with each other and make the slide base 510 be slidably connected to the slide-guiding rails 530. The core-pulling guide block 520 has a vertical portion 521 and a tilted portion 522 being bent connected to a lower end of the vertical portion 521, as shown in FIGS. 7 and 8. The sections of the vertical portion 521 and the tilted portion 522 are square shaped. The vertical portion 521 can pass through the first through hole 220 to be fixedly connected to the top clamping plate 100 by bolts. The tilted portion 522 can pass through the second through hole 320 to enter into the opening 410. The slide base 510 disposes a sliding hole 512 corresponding to the core-pulling guide block 520, as shown in FIGS. 4 to 6. The sliding hole 512 has a first vertical wall 512a being close to one side of the tilted portion 522 on an upper portion thereof, a first tilted wall 512b being close to the side of the tilted portion 522 on a lower portion thereof and being bent connected to the first vertical wall 512a, a second tilted wall 512c being far to the side of the tilted portion 522 on the upper portion thereof, and a second vertical wall 512d being far to the side of the tilted portion 522 on the lower portion thereof and being bent connected to the second tilted wall 512c. The tilted angles of the first and second tilted walls 512b and 512c are same as that of the tilted portion 522. The core-pulling guide block 520 is slidably inserted into the sliding hole 512.

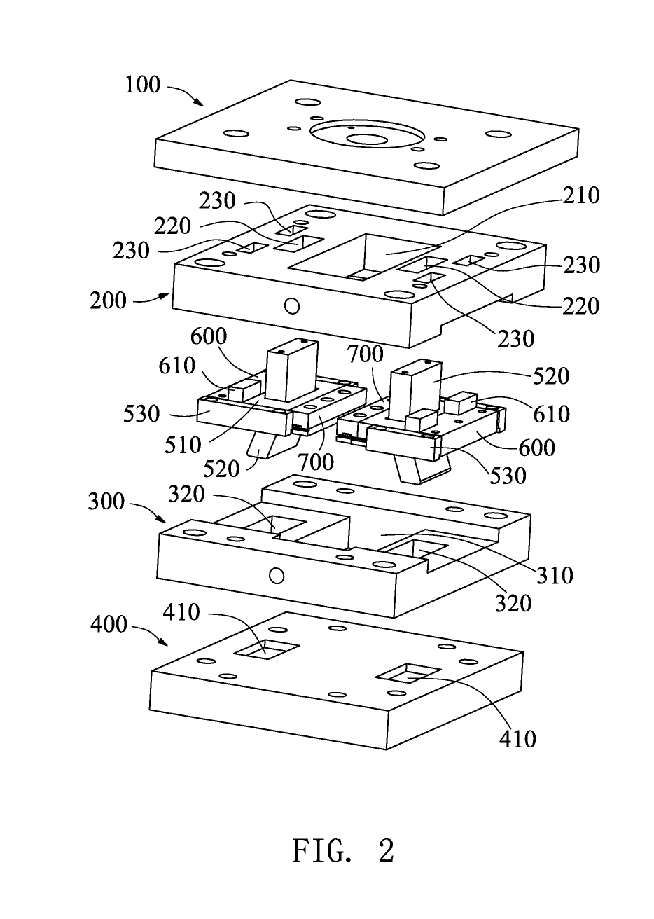

As shown in FIGS. 2 and 11, the scraping member 600 is located on the outside of the sliding direction of the slide base 510 and is connected to the cavity plate 200 by bolts. Preferably, the scraping member 600 disposes two latch blocks 610 protruding from a top surface thereof and separately corresponding to the holding holes 230. The two latch blocks 610 are separately held into the holding holes 230. After the mould 1000 being closed, the scraping member 600 leans against the slide base 510, the slide insert 700 is connected to one side of the slide base 510, which is far to the tilted portion 522, by bolts. Namely, the slide insert 700 is mounted on the inside of the slide base 510.

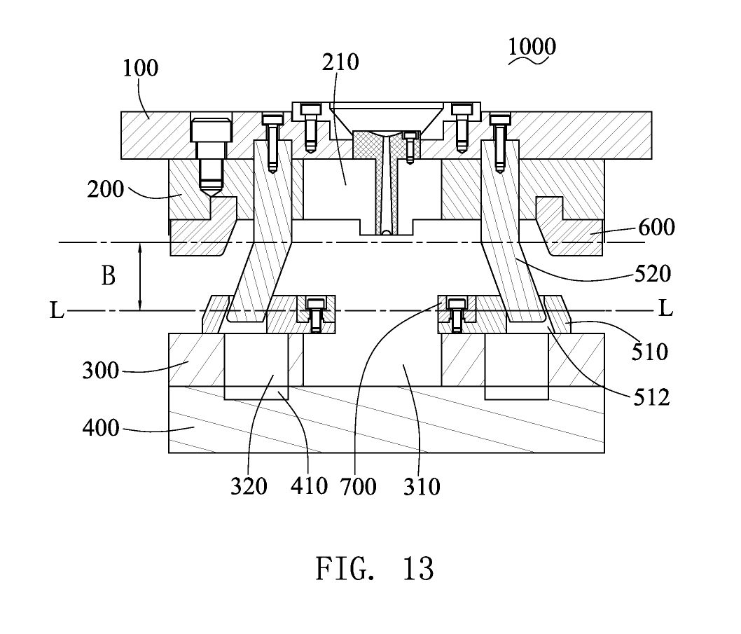

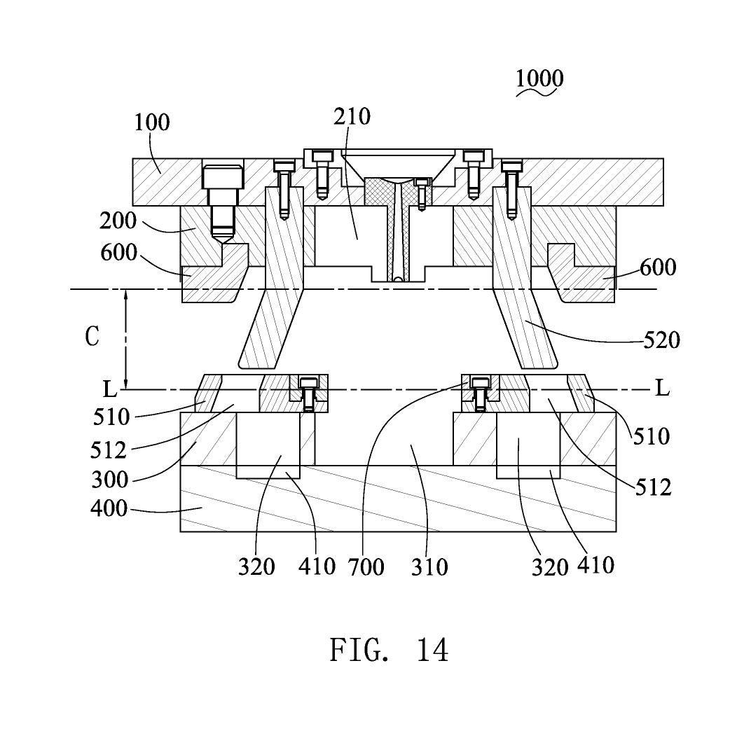

Referring to FIGS. 11 to 14, after closing the mould 1000, the scraping member 600 leans against the outside of the slide base 510 to position the slide base 510 for preventing the slide base 510 from swinging from left to right. The vertical portion 521 of the core-pulling guide block 520 leans on the first and second vertical walls 512a, 512d, and the tilted portion 522 thereof extends into the opening 410 of the supporting plate 400.

For convenience to describe the working process of the slide core-pulling delayed mechanism 500 of the mould 1000, a reference line L-L is set to be a movement reference of the slide core-pulling delayed mechanism 500, and the reference line L-L is set on a horizontal plane, on which a bending point 523 used to connect the vertical portion 521 and the tilted portion 522 is located before the core-pulling guide block moves upward.

Referring to FIGS. 11 to 14, when needing to open the mould 1000, the cavity plate 200 together with the scraping member 600 and the core-pulling guide block 520 are lifted upward, but the slide base 510 can not move and the slide insert 700 can not perform the core-pulling action before the scraping member 600 and the core-pulling guide block 520 arrive at a distance A. Whereby the core-pulling action of the slide insert 700 can be delayed. When the cavity plate 200 together with the scraping member 600 and the core-pulling guide block 520 are continuously lifted upward exceeding the distance A, such as arriving at a distance B, the tilted portion 522 can drive the slide base 510 to transversely move outward and simultaneously the slide insert 700 performs the core-pulling action. When the cavity plate 200 together with the scraping member 600 and the core-pulling guide block 520 are continuously lifted upward arriving at a distance C, the tilted portion 522 is just separated from the slide base 510. Now, the mould 1000 is completely opened.

As described above, the mould 1000 of the present invention employs the slide core-pulling delayed mechanism 500. During the dismoulding process, when the cavity plate 200 initially starts to be lifted upward, the slide base 510 has no movement and the slide insert 700 can not perform the core-pulling action. When the cavity plate 200 is lifted up to a determined distance, the slide base 510 just starts to transversely move outward, thereby making the core-pulling action of the slide insert 700 be performed. Therefore the core-pulling actions of the cavity plate 200 and the slide insert 700 of the present invention can not be interfered each other for making the dismoulding process be successfully completed and avoiding giving a harmful effect on the product.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A slide core-pulling delayed mechanism for being used in a core-pulling process of
a mould, comprising:
two slide-guiding rails, being parallel to each other;
a core-pulling guide block, having a vertical portion and a tilted portion being bent connected to a lower end of the vertical portion; and
a slide base, being slidably connected to the two slide-guiding rails and disposing a sliding hole corresponding to the core-pulling guide block;
wherein the sliding hole has a first vertical wall close to one side of the tilted portion on an upper portion thereof, a first tilted wall close to the side of the tilted portion on a lower portion thereof and bent connected to the first vertical wall, a second tilted wall far to the side of the tilted portion on the upper portion thereof, and a second vertical wall far to the side of the tilted portion and bent connected to the second tilted wall; and the core-pulling guide block is slidably inserted into the sliding hole.

2. The slide core-pulling delayed mechanism as claimed in claim 1, wherein the slide base disposes a first guiding groove on a lower portion thereof, each one of the two slide-guiding rails disposes a second guiding groove on a lower portion thereof, and the first and second guiding grooves can be engaged with each other for making the slide base be slidably connected to the two slide-guiding rails.

3. The slide core-pulling delayed mechanism as claimed in claim 1, wherein the tilted angles of the first and second tilted walls of the sliding hole are same as that of the tilted portion of the core-pulling guide block.

4. The slide core-pulling delayed mechanism as claimed in claim 1, wherein the horizontal width of the core-pulling guide block is equal to that of the sliding hole.

5. A mould, comprising a top clamping plate, a cavity plate connected to the top clamping plate, a core plate, a slide insert, a supporting plate for holding the core plate, and further comprising a slide core-pulling delayed mechanism located between the cavity plate and the core plate and including:
two slide-guiding rails, being parallel to each other;
a core-pulling guide block, having a vertical portion and a tilted portion being bent connected to a lower end of the vertical portion and extending away the slide insert, wherein the vertical portion passes through a first through hole formed on the cavity plates to be fixedly connected to the top clamping plate, and the tilted portion enters into a second through hole formed on the core plate; and
a slide base, being slidably connected to the two slide-guiding rails, disposing a sliding hole corresponding to the core-pulling guide block, and to which the slide insert being connected;
wherein the sliding hole has a first vertical wall close to one side of the tilted portion on an upper portion thereof, a first tilted wall close to the side of the tilted portion on a lower portion thereof and bent connected to the first vertical wall, a second tilted wall far to the side of the tilted portion on the upper portion thereof, and a second vertical wall far to the side of the tilted portion and bent connected to the second tilted wall; the tilted angles of the first and second tilted walls are same as that of the tilted portion of the core-pulling guide block; and the core-pulling guide block is slidably inserted into the sliding hole.

6. The mould as claimed in claim 5, wherein the slide base disposes a first guiding groove on a lower portion thereof, each one of the two slide-guiding rails disposes a second guiding groove on a lower portion thereof, and the first and second guiding grooves can be engaged with each other for making the slide base be slidably connected to the two slide-guiding rails.

7. The mould as claimed in claim 5, wherein the sections of the vertical portion and the tilted portion are square shaped.

8. The mould as claimed in claim 5, wherein the horizontal width of the core-pulling guide block is equal to that of the sliding hole.

9. The mould as claimed in claim 5, further comprising a scraping member located on the outside of the sliding direction of the slide base and fixedly connected to the cavity plate, wherein the scraping member leans against the slide base after the mould being closed.

10. The mould as claimed in claim 5, wherein the supporting plate disposes an opening corresponding to the second through hole and communicated with the second through hole.
